(19) United States
(12) Patent Application Publication
(10) Pub. No.: US 2011/0019529 A1
(43) Pub. Date: Jan. 27, 2011

(54) INTERFERENCE SUPPRESSION IN UPLINK ACKNOWLEDGEMENT

(75) Inventors: Renqiu Wang, San Diego, CA (US); Hao Xu, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/840,525

(22) Filed: Jul. 21, 2010

Related U.S. Application Data
(60) Provisional application No. 61/228,107, filed on Jul. 23, 2009.

(51) Int. Cl. H04J 11/00; H04B 15/00; H04L 12/26; H04W 4/00

(52) U.S. Cl. 370/209; 455/63.1; 370/252; 370/328

(57) ABSTRACT

The present disclosure proposes design of a pico/femto uplink acknowledgement (ACK) channel that improves the interference suppression for pico/femto base stations. The proposed design provides a two-layered cell-separation ACK channel structure for femto/pico cells by using computer generated sequences (CGS) and Discrete Fourier Transform (DFT) spreading. Thereby, ACK channels may be multiplexed across different femto/pico base stations with minimal interference. The proposed scheme is compatible with conventional standards for the base station in the macro cell and does not impose any changes on the macro cell.

### CLAIM OF PRIORITY UNDER 35 U.S.C. §119

The present application for patent claims benefit of U.S. Provisional Patent Application No. 61/228,107, entitled, “Interference Suppression in Uplink Acknowledgement,” filed Jul. 23, 2009, and assigned to the assignee hereof and hereby expressly incorporated by reference herein.

### TECHNICAL FIELD

The present disclosure generally relates to communication, and more specifically to interference suppression in an uplink channel of a wireless communication network.

### BACKGROUND

The 3rd Generation Partnership Project (3GPP) Long Term Evolution (LTE) represents a major advance in cellular technology and is the next step forward in cellular 3G services as a natural evolution of Global System for Mobile communications (GSM) and Universal Mobile Telecommunications System (UMTS). The LTE provides for an uplink speed of up to 50 megabits per second (Mbps) and a downlink speed of up to 100 Mbps and brings many technical benefits to cellular networks. The LTE is designed to meet carrier needs for high-speed data and media transport as well as high-capacity voice support. In addition, bandwidth is scalable from 1.25 MHz to 20 MHz. This suits the needs of different network operators that have different bandwidth allocations, and also allows operators to provide different services based on spectrum. The LTE standard is expected to improve spectral efficiency in 3G networks, allowing carriers to provide more data and voice services over a given bandwidth. The LTE encompasses high-speed data, multimedia unicast and multimedia broadcast services.

Physical layer of the LTE standard (LTE PHY) is a highly efficient means of conveying both data and control information between an enhanced base station (i.e., eNodeB) and mobile user equipment (UE). The LTE PHY employs advanced technologies that are new to cellular applications. These include Orthogonal Frequency Division Multiplexing (OFDM) and Multiple Input Multiple Output (MIMO) data transmission. In addition, the LTE PHY uses Orthogonal Frequency Division Multiple Access (OFDMA) on the downlink (DL) and Single Carrier-Frequency Division Multiple Access (SC-FDMA) on the uplink (UL). OFDMA allows data to be directed to or from multiple users on a subcarrier-by-subcarrier basis for a specified number of symbol periods.

The LTE-Advanced is an evolving mobile communication standard for providing fourth generation (4G) of wireless cellular services. Being defined as 3G technology, the LTE does not meet the requirements for 4G (also called IMT Advanced as defined by the International Telecommunication Union) such as peak data rates up to 1 Gbit/s. Besides the peak data rate, the LTE Advanced also targets faster switching between power states and improved performance at the cell edge.

Recently, design of heterogeneous networks with macro, pico and femto cells has received a lot of attention. A significant challenge for uplink (UL) channel design in heterogeneous networks is suppressing the strong interference from macro base stations as well as the interference from neighboring pico/femto base stations. In particular, if the pico/femto base stations utilize the same resources as the base station in the macro cell and operate under the current standards, uplink control signals such as Acknowledgement (ACK) and Channel Quality Indicator (CQI) for the pico/femto stations may collide with uplink ACK, CQI or Physical Uplink Shared Channel (PUSCH) resources of macro base station or other pico/femto base stations. The target pico/femto station may need detailed information about user assignment and payload of the interfering base stations to be able to cancel the interference. However, this may result in large amount of overhead at the femto base station which may be prohibitive to implement.

### SUMMARY

Certain aspects of the present disclosure provide a method for wireless communications. The method generally includes receiving a base sequence and one or more cell-specific sequences from a network, assigning at least one shift value to a user equipment (UE), sending information to the UE, wherein the information comprises the base sequence, one of the cell-specific sequences and the shift values, and receiving a signal from the UE, wherein the signal is generated based at least on the received information.

Certain aspects of the present disclosure provide a method for wireless communications. The method generally includes receiving at least two sequences and one or more shift values from a base station, generating an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode, and transmitting the ACK or the NACK signals to the base station.

Certain aspects of the present disclosure provide an apparatus for wireless communications. The apparatus generally includes logic for receiving a base sequence and one or more cell-specific sequences from a network, logic for assigning at least one shift value to a user equipment (UE), logic for sending information to the UE, wherein the information comprises the base sequence, one of the cell-specific sequences and the shift values, and logic for receiving a signal from the UE, wherein the signal is generated based at least on the received information.

Certain aspects of the present disclosure provide an apparatus for wireless communications. The apparatus generally includes logic for receiving at least two sequences and one or more shift values from a base station, logic for generating an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode, and logic for transmitting the ACK or the NACK signals to the base station.

Certain aspects of the present disclosure provide an apparatus for wireless communications. The apparatus generally includes means for receiving a base sequence and one or more cell-specific sequences from a network, means for assigning at least one shift value to a user equipment (UE), means for sending information to the UE, wherein the information comprises the base sequence, one of the cell-specific sequences and the shift values, and means for receiving a signal from the UE, wherein the signal is generated based at least on the received information.

Certain aspects of the present disclosure provide an apparatus for wireless communications. The apparatus generally includes means for receiving at least two sequences and one or more shift values from a base station, means for generating an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode, and means for transmitting the ACK or the NACK signals to the base station.

Certain aspects provide a computer-program product for wireless communications, comprising a computer-readable medium having instructions stored thereon, the instructions being executable by one or more processors. The instructions generally include instructions for receiving a base sequence and one or more cell-specific sequences from a network, instructions for assigning at least one shift value to a user equipment (UE), instructions for sending information to the UE, wherein the information comprises the base sequence, one of the cell-specific sequences and the shift values, and instructions for receiving a signal from the UE, wherein the signal is generated based at least on the received information.

Certain aspects provide a computer-program product for wireless communications, comprising a computer-readable medium having instructions stored thereon, the instructions being executable by one or more processors. The instructions generally include instructions for receiving at least two sequences and one or more shift values from a base station, instructions for generating an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode, and instructions for transmitting the ACK or the NACK signals to the base station.

Certain aspects of the present disclosure provide an apparatus for wireless communications. The apparatus generally includes at least one processor configured to receive a base sequence and one or more cell-specific sequences from a network, assign at least one shift value to a user equipment (UE), send information to the UE, wherein the information comprises the base sequence, one of the cell-specific sequences and the shift values, and receive a signal from the UE, wherein the signal is generated based at least on the received information.

Certain aspects of the present disclosure provide an apparatus for wireless communications. The apparatus generally includes at least one processor configured to receive at least two sequences and one or more shift values from a base station, generate an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode, and transmit the ACK or the NACK signals to the base station.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a frame structure for non-coherent uplink acknowledgement transmission in pico/femto cells using normal cyclic prefix (CP), in accordance with certain aspects of the present disclosure.

FIG. 2 illustrates a frame structure for coherent uplink acknowledgement transmission in pico/femto cells using normal CP, in accordance with certain aspects of the present disclosure.

FIG. 3 illustrates performance comparison of coherent and non-coherent structures, in accordance with certain aspects of the present disclosure.

FIG. 4 illustrates example operations for configuring and receiving signals in an uplink control channel that may be performed by a base station, in accordance with certain aspects of the present disclosure.

FIG. 4A illustrates example components capable of performing the operations illustrated in FIG. 4.

FIG. 5 illustrates example operations for transmitting signals in an uplink control channel that may be performed by a user equipment, in accordance with certain aspects of the present disclosure.

FIG. 5A illustrates example components capable of performing the operations illustrated in FIG. 5.

FIG. 6 illustrates a diagram of a wireless communication system configured to support a number of users, in accordance with certain aspects of the present disclosure.

FIG. 7 illustrates a diagram of a wireless communication system comprising macro cells, femto cells and pico cells, in accordance with certain aspects of the present disclosure.

FIG. 8 illustrates a diagram of a communication system where one or more femto nodes are deployed within a network environment, in accordance with certain aspects of the present disclosure.

FIG. 9 illustrates a diagram of a coverage map where several tracking areas, routing areas or location areas are defined, in accordance with certain aspects of the present disclosure.

FIG. 10 illustrates a diagram of a multiple access wireless communication system, in accordance with certain aspects of the present disclosure.

FIG. 11 illustrates a schematic of a multiple input multiple output (MIMO) communication system, in accordance with certain aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

Certain aspects of the present disclosure propose designs of a non-coherent and a coherent pico/femto uplink acknowledgement (ACK) channel that significantly improve the interference suppression for pico/femto base stations. The proposed designs provide two-layer separation between pico/femto cells for the ACK channel by using computer generated sequences (CGS) and Discrete Fourier Transform (DFT) spreading. Thereby, ACK channels can be multiplexed across different femto/pico base stations with minimal interference. The proposed schemes are compatible with conventional standards for the base station in the macro cell and do not impose any changes on the macro cell.

If the pico/femto base stations were to directly follow the current specification for a macro base station, the uplink control signals (e.g., ACK and channel quality indicator (CQI)) would collide with uplink ACK, CQI or physical uplink shared channel (PUSCH) resources of macro base station or other pico/femto base stations. As a result, the target pico/femto base stations would require detailed information about the interfering base station, such as user assignment and payload to be able to cancel the interference. However, this may result in large amount of overhead at the femto base station which may be prohibitive to implement.

Certain aspects of the present disclosure provide a non-coherent uplink (UL) ACK channel design for pico/femto cells. The proposed design is backward compatible, in which the macro cell base stations may continue using a conventional channel structure without any changes. The proposed non-coherent ACK channel structure aids interference management by exploiting smaller cell size of the pico/femto cells compared to the macro cell, as well as low mobility of UEs in the pico/femto cells.

For certain aspects of the present disclosure, a non-coherent frame structure for ACK transmission may be designed as follows. First, a base sequence and a DFT sequence may be assigned to each pico/femto base station according to their cell identification (ID) or global ID. Therefore, there will be two layers of protection against interference between pico/femto cells. Different cells use different base sequences that have low cross correlation as the first layer of protection. For example, there may be total of 30 base sequences for 12 subcarriers.

For certain aspects, the second layer of protection against interference may be a DFT sequence. Different columns of a DFT matrix may be used as DFT sequences for different pico/femto cells. For example, the DFT matrix in the LTE standard has seven columns when normal Cyclic Prefix (CP) is used and six columns when extended CP is used. Therefore, the DFT columns may be assigned to seven or six pico/femto cells for normal CP or extended CP, respectively. Because UEs that communicate with a pico or femto base station in a cell usually operate at low speed, the orthogonality between different DFT columns may be maintained. Therefore, all of the interference caused by other pico/femto cells may be suppressed.

For certain aspects, UEs communicating with a base station may be separated by different shifts of a common base sequence. Therefore, two or more different shifts may be assigned to each UE. For example, in a single input single output SISO case, two shift values may be assigned to a UE, one shift value for ACK transmission and the other for NACK transmission. In a multiple input multiple output (MIMO) case, 2×n shift values may be assigned to each UE, in which n is the number of channels between the UE and the base station.

Depending on the channel type, the shifted base sequences should be separated by certain number of subcarriers to be orthogonal. For example, in the LTE standard, the shifted base sequences may be separated by one subcarrier for normal CP and by two subcarriers for extended CP. Therefore, for a Resource Block (RB) with 12 subcarriers, six different shifted versions of a common base sequence may be available that could be assigned to three UEs simultaneously for normal CP. For the extended CP, four different shifted base sequences may be available that could be assigned to two UEs.

Unlike the coherent scheme, pilot signals are not transmitted in non-coherent scheme, therefore, channel conditions are not known at the receiver. For certain aspects, an energy detection technique may be used to differentiate between ACK signals and NACK signals at the receiver. Since the two signals (e.g., ACK and NACK) that are generated utilizing two different shifted base sequences are orthogonal, the transmitted signal will produce a peak while the other will be nearly zero.

For certain aspects, a tri-state energy detection scheme may be used to detect ACK, NACK or Discontinuous Transmission (DTX) signals. To do so, a first and a second energy value may be determined by multiplying the received signal with two shifted base sequences, one of which corresponds to the ACK signal and the other corresponds to the NACK signal. Noise variance may be determined by selecting the smaller of the two energy values. Ratio of the first and the second energy values may be compared with a threshold. The threshold may be selected as a function of the noise variance.

If the ratio is less than the threshold and greater than the inverse of the threshold, DTX may be declared. Otherwise, if the ratio is larger than the threshold and the first energy value is larger than the second energy value, ACK may be declared. If the ratio is less than the inverse of the threshold and the second energy value is larger than the first energy value, NACK may be declared or vice versa.

For certain aspects, depending on the load of pico/femto cells, DFT sequences may be assigned dynamically to the pico/femto cells to increase user capacity of the cells, if needed. Therefore, more than one DFT sequence may be assigned to a pico/femto cell with a higher load to increase the number of supported UEs. For example, one DFT sequence may be assigned to a pico/femto cells that support up to three UEs, two DFT sequences may be assigned to a pico/femto cell that supports up to six users, and so on.

For certain aspects, the proposed two-layer decoding for interference suppression may be applied to a coherent UL control scheme for pico/femto base stations. In particular, in addition to base sequence separation, DFT/Walsh code may be assigned to different pico/femto cells for inter-cell interference management instead of conventional intra-cell interference management. With this modification in the LTE standard, each cell may support up to six UEs per RB for normal CP.

Since the coherent scheme involves transmission of a reference signal (i.e., a pilot), channel parameters may be estimated using the reference signal. Therefore, only one shifted base sequence may be enough per UE for transmitting ACK/NACK messages in the coherent scheme, since the channel phase is known from processing the reference signal. For a DFT matrix with three columns, perfect cell separation may be achieved among three pico/femto cells, each of which uses a different column of the DFT matrix.

There is a trade-off between user-capacity of each cell and interference suppression. For the coherent and non-coherent structures, the trade off is between user-capacity and cell orthogonality. The non-coherent structure has lower user capacity for each pico/femto cell than the coherent structure (three vs. six), but higher number of cells (i.e., seven cells vs. three) can transmit simultaneously utilizing same resources with virtually orthogonal channels.

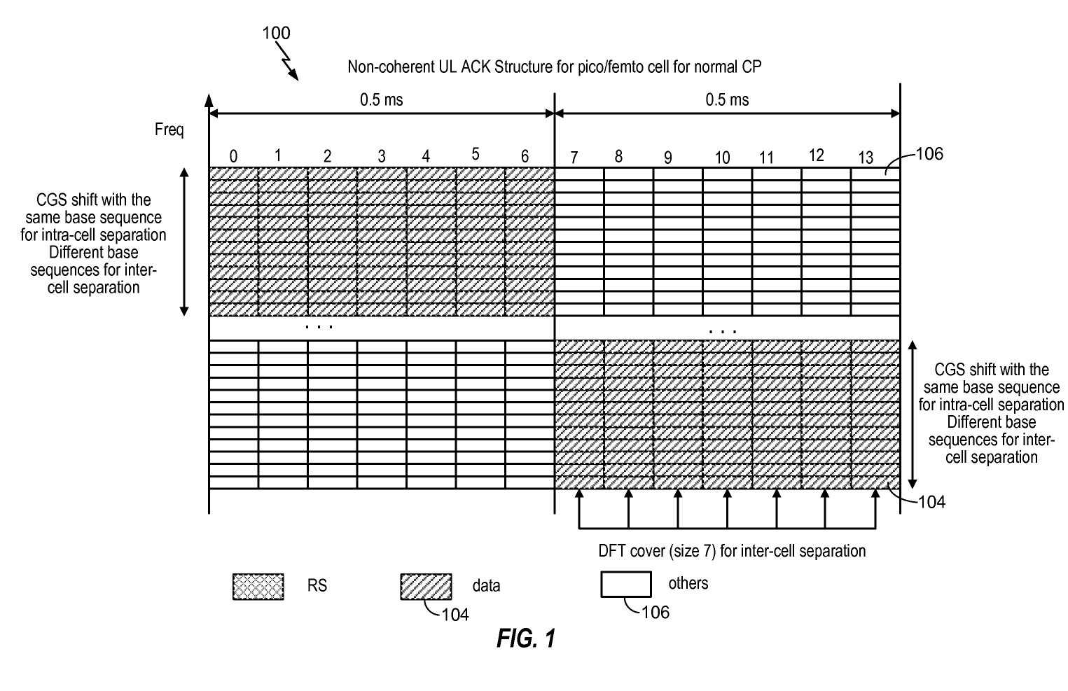

FIG. 1 illustrates a frame structure 100 for non-coherent uplink acknowledgement transmission in pico/femto cells using normal CP, in accordance with certain aspects of the present disclosure. As illustrated, data 104 and other signals 106 are transmitted in several frames over different subcarriers. Different base sequences may be assigned to different pico/femto cells for inter-cell separation (i.e., separating the signals that belong to different pico/femto cells). Shifted versions of a common base sequence may be applied to different frames for intra-cell separation (i.e., separation between the UEs in each pico/femto cell). In addition, two different shifts of the base sequence may be assigned to each UE (e.g., UE1 106, UE2 108, and UE3 110) that may be used to transmit data. A 7×7 DFT matrix may be utilized to separate signals transmitted in seven different cells. Each column of the DFT matrix may be assigned to a different pico/femto cell.

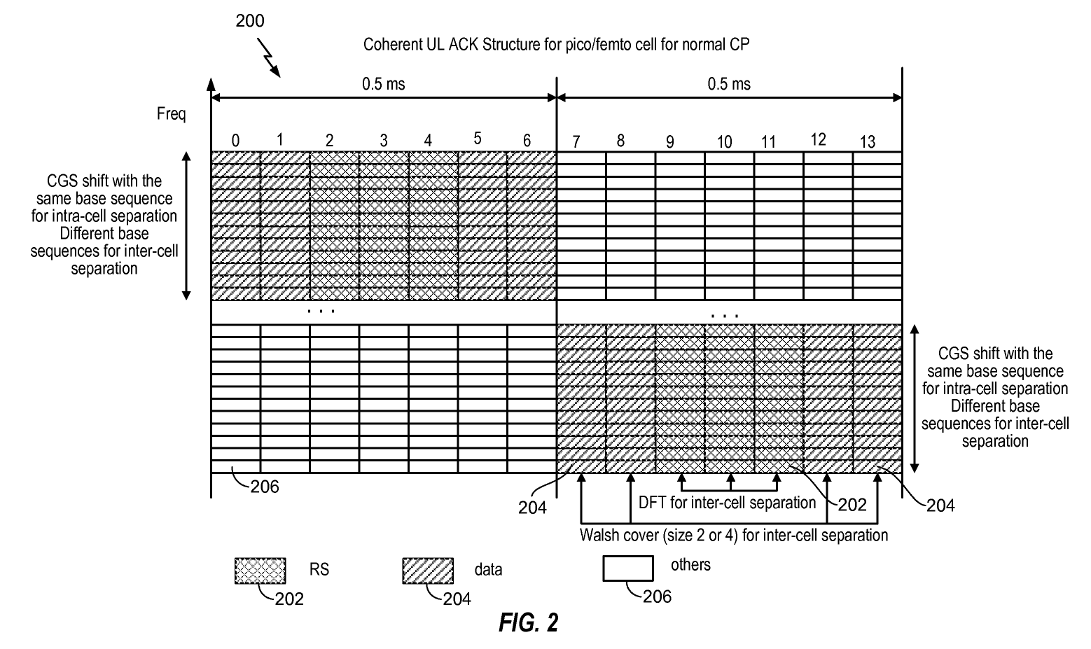

FIG. 2 illustrates a frame structure 200 for coherent uplink acknowledgement transmission in pico/femto cells using normal CP, in accordance with certain aspects of the present disclosure. As illustrated, the reference signals (RS) 202, data 204 and other signals 206 are transmitted in several frames over different subcarriers. The reference signals are used at the receiver to estimate channel parameters. A 3×3 DFT matrix may be utilized to separate reference signals transmitted in three different cells. Each column of the DFT matrix may be assigned to a different pico/femto cell for transmission of the reference signal. In addition, size two or four Walsh code may be utilized for inter-cell separation.

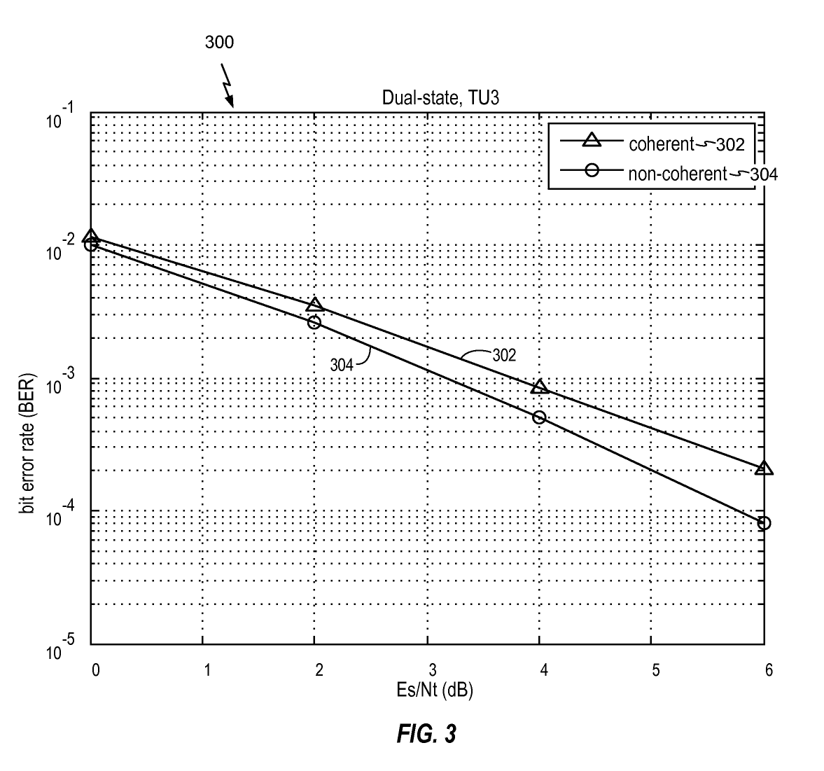

In FIG. 3, a plot 300 depicts performance results of the proposed ACK channel design for coherent 302 and non-coherent 304 structures, with two layer decoding. The coherent structure supports three cells and six UEs per cell. The non-coherent structure supports seven cells and three UEs per cell. It can be observed that the non-coherent scheme performs slightly worse than the coherent scheme. However, the non-coherent structure has higher user capacity compared to the coherent structure (21 vs. 18).

It is believed that low mobility may be typical for UEs in pico and femto cells. For example, a pico cell can entail an integrated system of wireless components that is either fixed within a room or another small space, or that moves together on a person or in a vehicle. As another example, a femto cell may be used within a facility for a person working or residing within that facility for an extended period to extend outside macro coverage or to leverage an advantage billing arrangement for a closed subscriber system. Given the low mobility in pico/femto cells, the present disclosure allows nearly perfect isolation between ACK channels of these cells.

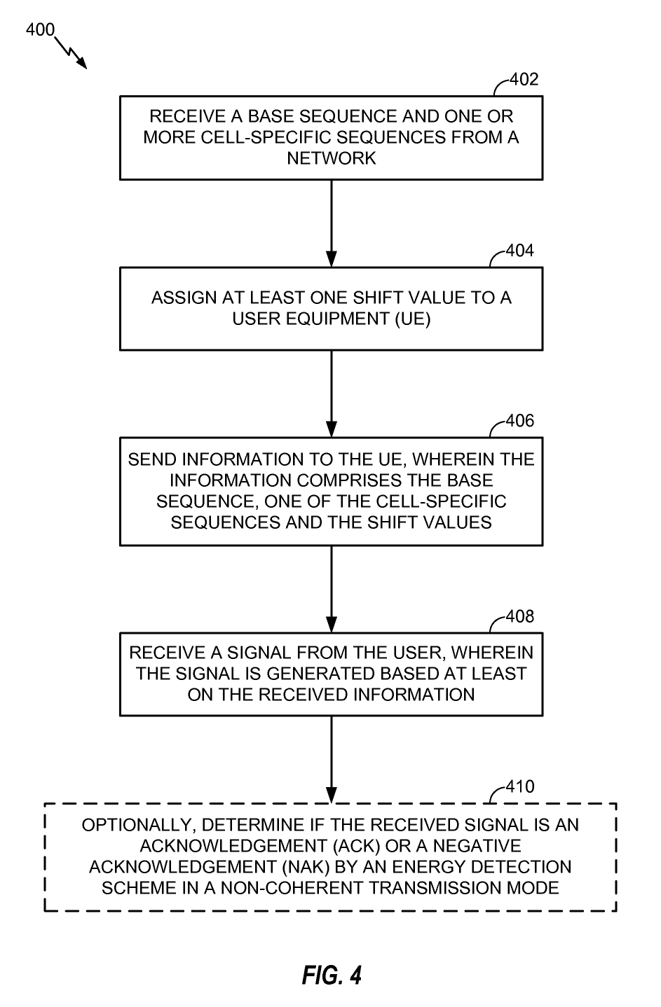

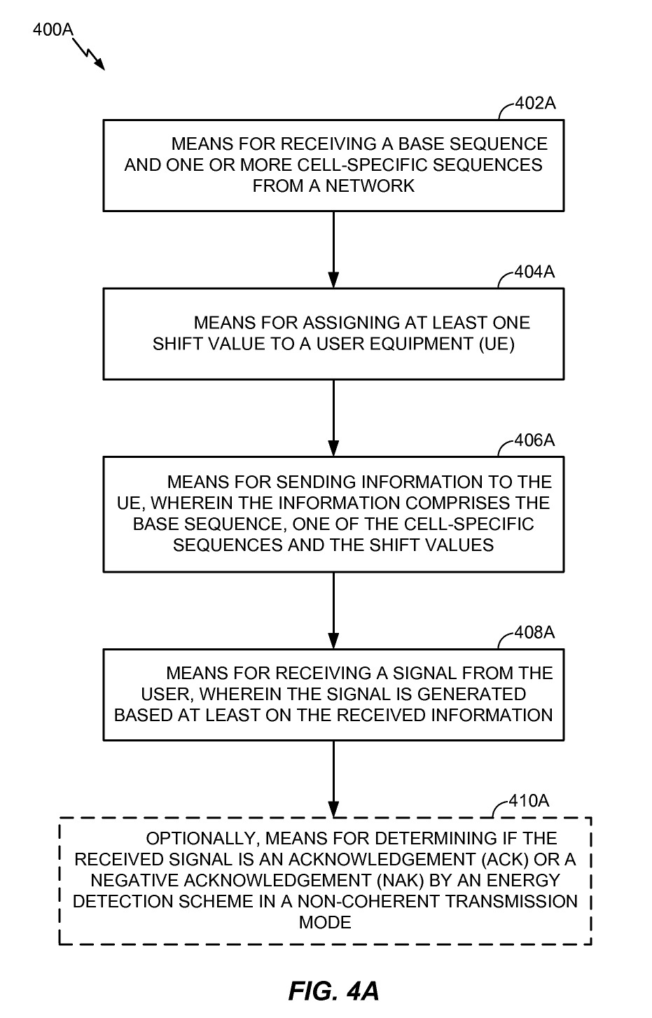

FIG. 4 illustrates example operations for configuring and receiving signals in an uplink control channel that may be performed by a base station, in accordance with certain aspects of the present disclosure. At 402, a base station in a pico/femto cell receives a base sequence and a cell-specific sequence from a network. The base sequence may be a computer generated sequence and cell-specific sequence may be a column of an orthogonal matrix such as a DFT matrix. At 404, the base station assigns at least one shift value for coherent transmission or at least two shift values for non-coherent transmission to a user equipment (UE).

At 406, the base station sends information to the UE, wherein the information comprises the base sequence, the cell-specific sequence and the shift values. The UE may use one of the shift values to generate an ACK signal and another shift value to generate a NACK signal. At 408, the base station receives a signal from the UE, wherein the signal is generated based at least on the received information. At 410, the base station may determine if the received signal is an ACK or a NACK signal by an energy detection scheme in a non-coherent transmission mode.

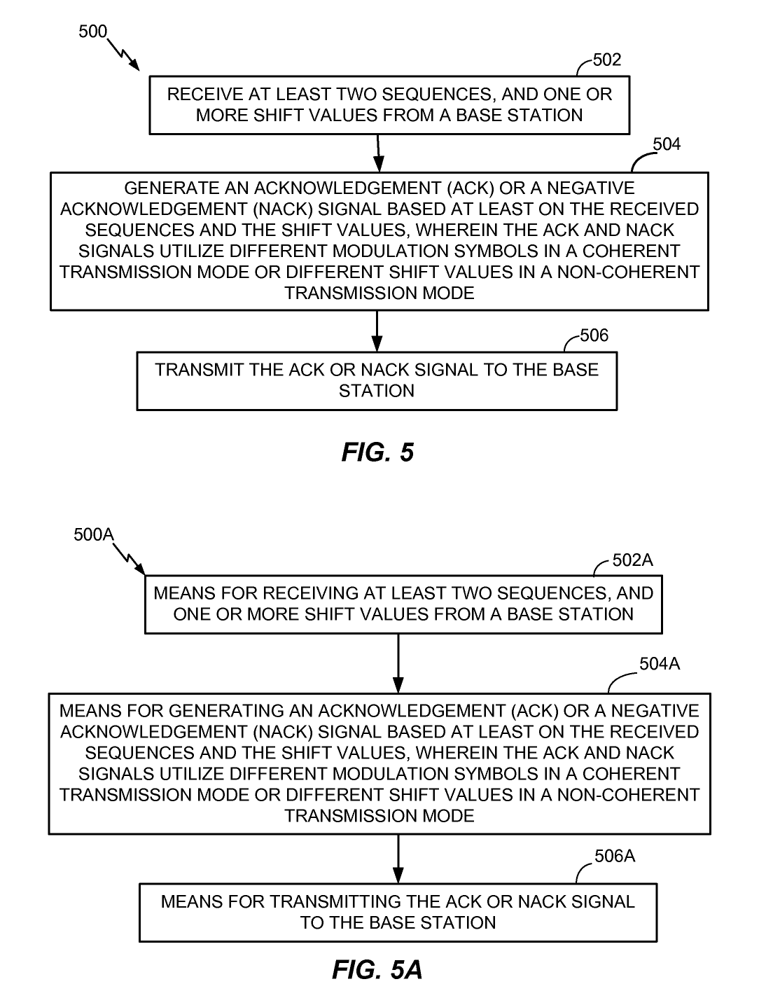

FIG. 5 illustrates example operations for transmitting signals in an uplink control channels that may be performed by a user equipment, in accordance with certain aspects of the present disclosure. At 502, the UE receives at least two sequences and one or more shift values from a base station. The two sequences may include a base sequence and a DFT sequence. At 504, the UE generates an acknowledgement (ACK) or a negative acknowledgement (NACK) signal based at least on the received sequences and the shift values, wherein the ACK and NACK signals utilize different modulation symbols for a coherent transmission mode or different shift values for a non-coherent transmission mode. At 506, the UE transmits the ACK or NACK signals to the base station.

It should be noted that the present disclosure explains the two-layer separation for interference suppression of ACK and NACK signals, however, the above scheme may be applied to other signals without departing from the scope of this disclosure.

For certain aspects, dynamic ACK resource allocation may be implemented for femto cells. Therefore, more than one DFT sequence may be assigned to each femto base station to increase user capacity of the femto cell.

Given that the proposed scheme does not need to monitor the signals transmitted in the neighboring macro cells for interference cancellation, receiver complexity of the pico/femto base stations may be reduced.

In another aspect, interference management between pico/femto and macro base stations may be performed either by Frequency Division Multiplexing (FDM) between pico/femto and macro base station, or by the proposed CGS sequence separation and interference cancellation.

In some aspects, the teachings herein may be employed in a network that includes macro scale coverage (e.g., a large area cellular network such as a 3G (Third Generation) networks, typically referred to as a macro cell network) and smaller scale coverage (e.g., a residence-based or building-based network environment). As an access terminal (“AT”) moves through such a network, the access terminal may be served in certain locations by access nodes (“ANs”) that provide macro coverage while the access terminal may be served at other locations by access nodes that provide smaller scale coverage. In some aspects, the smaller coverage nodes may be used to provide incremental capacity growth, in-building coverage, and different services (e.g., for a more robust user experience).

In the discussion herein, a node that provides coverage over a relatively large area may be referred to as a macro node. A node that provides coverage over a relatively small area (e.g., a residence) may be referred to as a femto node. A node that provides coverage over an area that is smaller than a macro area and larger than a femto area may be referred to as a pico node (e.g., providing coverage within a commercial building).

A cell associated with a macro node, a femto node, or a pico node may be referred to as a macro cell, a femto cell, or a pico cell, respectively. In some implementations, each cell may be further associated with (e.g., divided into) one or more sectors.

In various applications, other terminology may be used to reference a macro node, a femto node, or a pico node. For example, a macro node may be configured or referred to as an access node, base station, access point, eNodeB, macro cell, and so on. Also, a femto node may be configured or referred to as a Home NodeB, Home eNodeB, access point base station, femto cell, and so on.

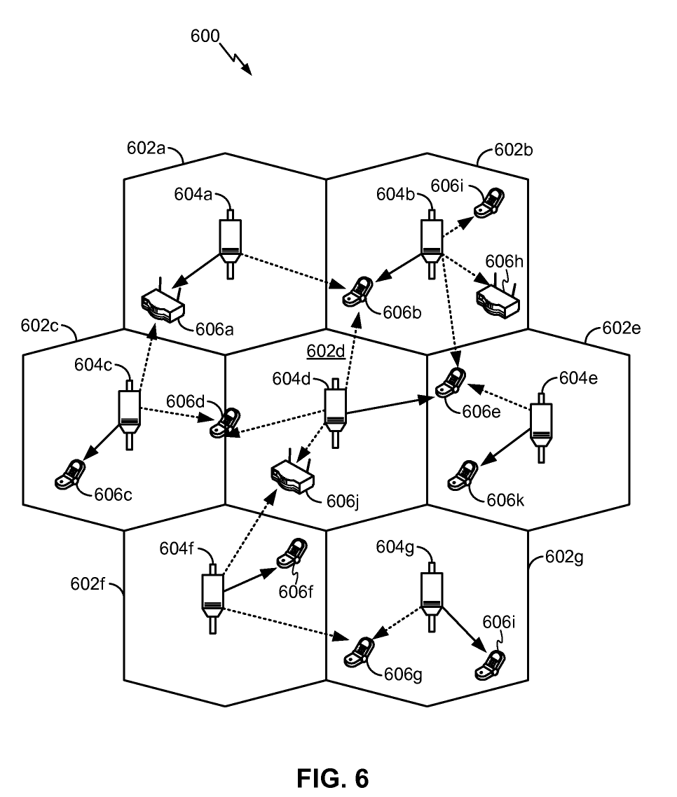

FIG. 6 illustrates a wireless communication system 600, configured to support a number of users, in which the teachings herein may be implemented. The system 600 provides communication for multiple cells 602, such as, for example, macro cells 602a-602g, with each cell being serviced by a corresponding access node 604 (e.g., access nodes 604a-604g). As shown in FIG. 6, access terminals 606 (e.g., access terminals 606a-606l) may be dispersed at various locations throughout the system over time. Each access terminal 606 may communicate with one or more access nodes 604 on a forward link (“FL”) and/or a reverse link (“RL) at a given moment, depending upon whether the access terminal 606 is active and whether it is in soft handoff, for example. The wireless communication system 600 may provide service over a large geographic region. For example, macro cells 602a-602g may cover a few blocks in a neighborhood.

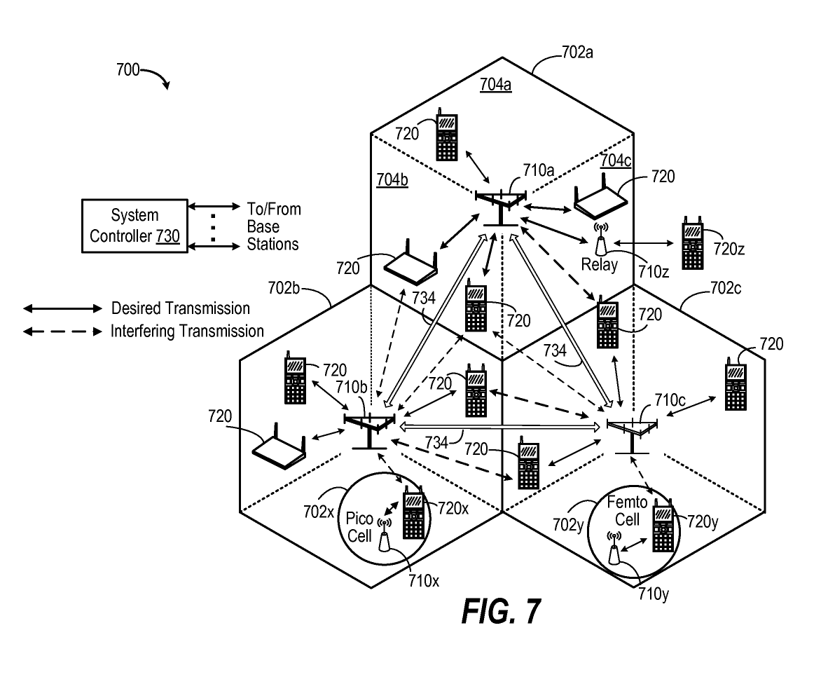

In the example shown in FIG. 7, base stations 710a, 710b and 710c may be macro base stations for macro cells 702a, 702b and 702c, respectively. Base station 710x may be a pico base station for a pico cell 702x communicating with terminal 720x. Base station 710y may be a femto base station for a femto cell 702y communicating with terminal 720y. Although not shown in FIG. 7 for simplicity, the macro cells may overlap at the edges. The pico and femto cells may be located within the macro cells (as shown in FIG. 7) or may overlap with macro cells and/or other cells.

Wireless network 700 may also include relay stations, e.g., a relay station 710z that communicates with terminal 720z. A relay station is a station that receives a transmission of data and/or other information from an upstream station and sends a transmission of the data and/or other information to a downstream station. The upstream station may be a base station, another relay station or a terminal. The downstream station may be a terminal, another relay station or a base station. A relay station may also be a terminal that relays transmissions for other terminals. A relay station may transmit and/or receive low reuse preambles. For example, a relay station may transmit a low reuse preamble in similar manner as a pico base station and may receive low reuse preambles in similar manner as a terminal.

A network controller 730 may couple to a set of base stations and provide coordination and control for these base stations. Network controller 730 may be a single network entity or a collection of network entities. Network controller 730 may communicate with base stations 710 via a backhaul. Backhaul network communication 734 can facilitate point-to-point communication between base stations 710a-710c employing such a distributed architecture. Base stations 710a-710c may also communicate with one another, e.g., directly or indirectly via wireless or wireline backhaul.

Wireless network 700 may be a homogeneous network that includes only macro base stations (not shown in FIG. 7). Wireless network 700 may also be a heterogeneous network that includes base stations of different types, e.g., macro base stations, pico base stations, home base stations, relay stations, etc. These different types of base stations may have different transmit power levels, different coverage areas and different impact on interference in wireless network 700. For example, macro base stations may have a high transmit power level (e.g., 20 Watts) whereas pico and femto base stations may have a low transmit power level (e.g., 9 Watt). The techniques described herein may be used for homogeneous and heterogeneous networks.

Terminals 720 may be dispersed throughout wireless network 700, and each terminal may be stationary or mobile. A terminal may also be referred to as an access terminal (AT), a mobile station (MS), user equipment (UE), a subscriber unit, a station, etc. A terminal may be a cellular phone, a personal digital assistant (PDA), a wireless modem, a wireless communication device, a handheld device, a laptop computer, a cordless phone, a wireless local loop (WLL) station, etc. A terminal may communicate with a base station via the downlink and uplink. The downlink (or forward link) refers to the communication link from the base station to the terminal, and the uplink (or reverse link) refers to the communication link from the terminal to the base station.

A terminal may be able to communicate with macro base stations, pico base stations, femto base stations, and/or other types of base stations. In FIG. 7, a solid line with double arrows indicates desired transmissions between a terminal and a serving base station, which is a base station designated to serve the terminal on the downlink and/or uplink. A dashed line with double arrows indicates interfering transmissions between a terminal and a base station. An interfering base station is a base station causing interference to a terminal on the downlink and/or observing interference from the terminal on the uplink.

Wireless network 700 may support synchronous or asynchronous operation. For synchronous operation, the base stations may have the same frame timing, and transmissions from different base stations may be aligned in time. For asynchronous operation, the base stations may have different frame timing, and transmissions from different base stations may not be aligned in time. Asynchronous operation may be more common for pico and femto base stations, which may be deployed indoors and may not have access to a synchronizing source such as a Global Positioning System (GPS).

In one aspect, to improve system capacity, the coverage area 702a, 702b, or 702c corresponding to a respective base station 710a-710c can be partitioned into multiple smaller areas (e.g., areas 704a, 704b, and 704c). Each of the smaller areas 704a, 704b, and 704c can be served by a respective base transceiver subsystem (BTS, not shown). As used herein and generally in the art, the term “sector” can refer to a BTS and/or its coverage area depending on the context in which the term is used. In one example, sectors 704a, 704b, 704c in a cell 702a, 702b, 702c can be formed by groups of antennas (not shown) at base station 710, where each group of antennas is responsible for communication with terminals 720 in a portion of the cell 702a, 702b or 702c. For example, a base station 710 serving cell 702a can have a first antenna group corresponding to sector 704a, a second antenna group corresponding to sector 704b and a third antenna group corresponding to sector 704c. However, it should be appreciated that the various aspects disclosed herein can be used in a system having sectorized and/or unsectorized cells. Further, it should be appreciated that all suitable wireless communication networks having any number of sectorized and/or unsectorized cells are intended to fall within the scope of the hereto appended claims. For simplicity, the term “base station” as used herein can refer both to a station that serves a sector as well as a station that serves a cell. It should be appreciated that as used herein, a downlink sector in a disjoint link scenario is a neighbor sector. While the following description generally relates to a system in which each terminal communicates with one serving access point for simplicity, it should be appreciated that terminals can communicate with any number of serving access points.

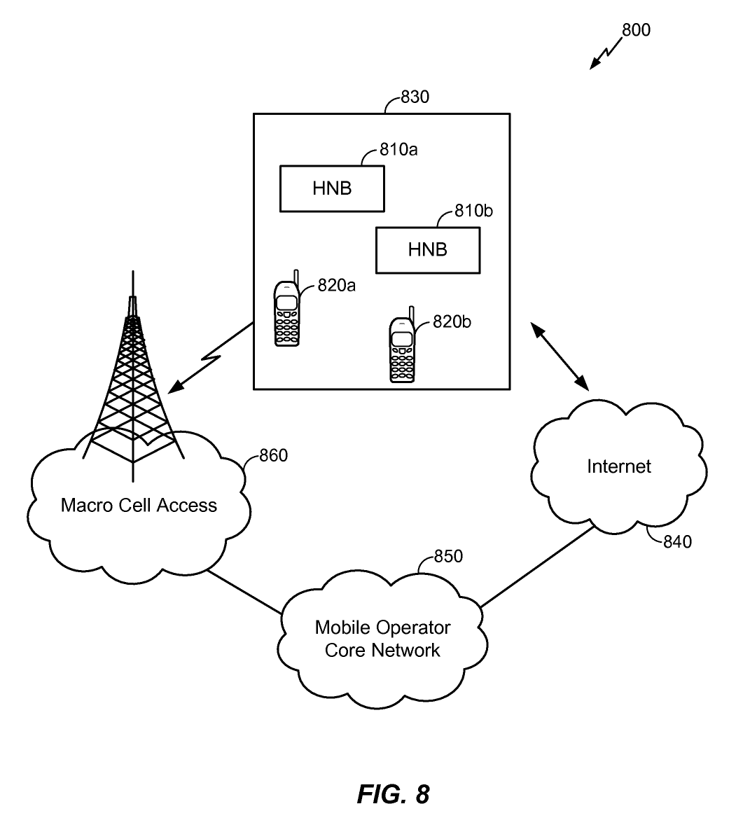

FIG. 8 illustrates an exemplary communication system 800 where one or more femto nodes are deployed within a network environment. Specifically, the system 800 includes multiple femto nodes 810 (e.g., femto nodes 810a and 810b) installed in a relatively small scale network environment (e.g., in one or more user residences 830). Each femto node 810 may be coupled to a wide area network 840 (e.g., the Internet) and a mobile operator core network 850 via a DSL router, a cable modem, a wireless link, or other connectivity means (not shown). As will be discussed below, each femto node 810 may be configured to serve associated access terminals 820 (e.g., access terminal 820a) and, optionally, alien access terminals 820 (e.g., access terminal 820b). In other words, access to femto nodes 810 may be restricted whereby a given access terminal 820 may be served by a set of designated (e.g., home) femto node(s) 810 but may not be served by any non-designated femto nodes 810 (e.g., a neighbor's femto node 810).

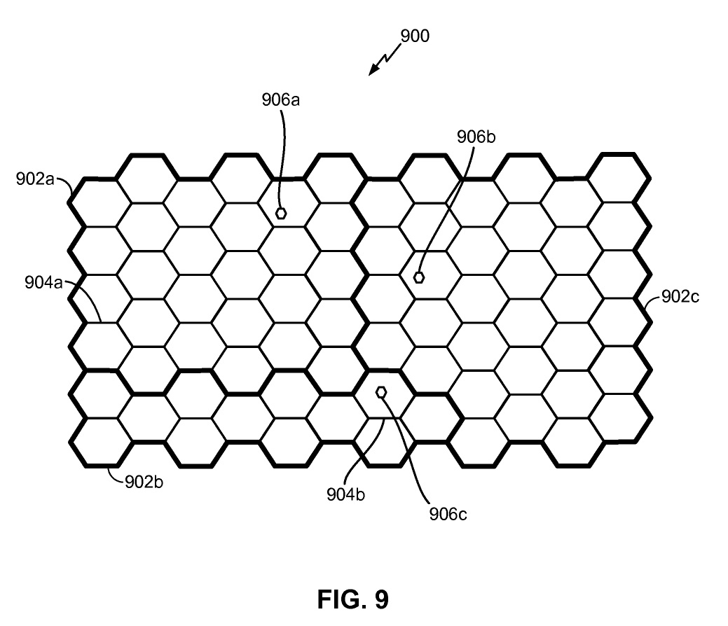

FIG. 9 illustrates an example of a coverage map 900 where several tracking areas 902 (or routing areas or location areas) are defined, each of which includes several macro coverage areas 904. Here, areas of coverage associated with tracking areas 902a, 902b and 902c are delineated by the wide lines and the macro coverage areas 904 are represented by the hexagons. The tracking areas 902 also include femto coverage areas 906. In this example, each of the femto coverage areas 906 (e.g., femto coverage area 906c) is depicted within a macro coverage area 904 (e.g., macro coverage area 904b). It should be appreciated, however, that a femto coverage area 906 may not lie entirely within a macro coverage area 904. In practice, a large number of femto coverage areas 906 may be defined with a given tracking area 902 or macro coverage area 904. Also, one or more pico coverage areas (not shown) may be defined within a given tracking area 902 or macro coverage area 904.

Referring again to FIG. 8, the owner of a femto node 810 may subscribe to mobile service, such as, for example, 3G mobile service, offered through the mobile operator core network 850. In addition, an access terminal 820 may be capable of operating both in macro environments and in smaller scale (e.g., residential) network environments. In other words, depending on the current location of the access terminal 820, the access terminal 820 may be served by an access node 860 of the macro cell mobile network 850 or by any one of a set of femto nodes 810 (e.g., the femto nodes 810a and 810b that reside within a corresponding user residence 830). For example, when a subscriber is outside his home, he is served by a standard macro access node (e.g., node 860) and when the subscriber is at home, he is served by a femto node (e.g., node 810a). Here, it should be appreciated that a femto node 810 may be backward compatible with existing access terminals 820.

A femto node 810 may be deployed on a single frequency or, in the alternative, on multiple frequencies. Depending on the particular configuration, the single frequency or one or more of the multiple frequencies may overlap with one or more frequencies used by a macro node (e.g., node 860).

In some aspects, an access terminal 820 may be configured to connect to a preferred femto node (e.g., the home femto node of the access terminal 820) whenever such connectivity is possible. For example, whenever the access terminal 820 is within the user's residence 830, it may be desired that the access terminal 820 communicate only with the home femto node 810.

In some aspects, if the access terminal 820 operates within the macro cellular network 850 but is not residing on its most preferred network (e.g., as defined in a preferred roaming list), the access terminal 820 may continue to search for the most preferred network (e.g., the preferred femto node 810) using a Better System Reselection (“BSR”), which may involve a periodic scanning of available systems to determine whether better systems are currently available, and subsequent efforts to associate with such preferred systems. With the acquisition entry, the access terminal 820 may limit the search for specific band and channel. For example, the search for the most preferred system may be repeated periodically. Upon discovery of a preferred femto node 810, the access terminal 820 selects the femto node 810 for camping within its coverage area.

A femto node may be restricted in some aspects. For example, a given femto node may only provide certain services to certain access terminals. In deployments with so-called restricted (or closed) association, a given access terminal may only be served by the macro cell mobile network and a defined set of femto nodes (e.g., the femto nodes 810 that reside within the corresponding user residence 830). In some implementations, a node may be restricted to not provide, for at least one node, at least one of signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (“CSG”) may be defined as the set of access nodes (e.g., femto nodes) that share a common access control list of access terminals. A channel on which all femto nodes (or all restricted femto nodes) in a region operate may be referred to as a femto channel.

Various relationships may thus exist between a given femto node and a given access terminal. For example, from the perspective of an access terminal, an open femto node may refer to a femto node with no restricted association. A restricted femto node may refer to a femto node that is restricted in some manner (e.g., restricted for association and/or registration). A home femto node may refer to a femto node on which the access terminal is authorized to access and operate on. A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that authorized to access the restricted femto node. A guest access terminal may refer to an access terminal with temporary access to the restricted femto node. An alien access terminal may refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionalities in the context of a femto node. It should be appreciated, however, that a pico node may provide the same or similar functionality for a larger coverage area. For example, a pico node may be restricted; a home pico node may be defined for a given access terminal, and so on.

A wireless multiple-access communication system may simultaneously support communication for multiple wireless access terminals. As mentioned above, each terminal may communicate with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out system, a multiple-in-multiple-out (“MIMO”) system or some other type of system.

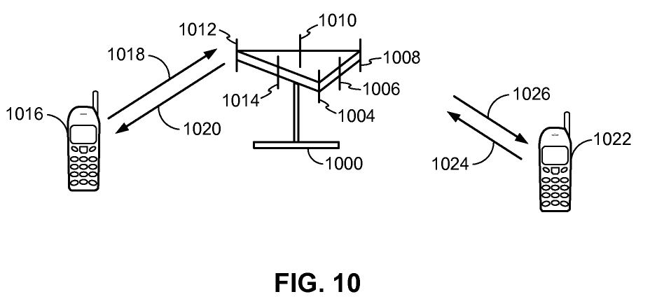

Referring to FIG. 10, a multiple access wireless communication system according to one aspect is illustrated. An access point (AP) 1000 includes multiple antenna groups, one including 1004 and 1006, another including 1008 and 1010, and an additional including 1012 and 1014. In FIG. 10, only two antennas are shown for each antenna group, however, more or fewer antennas may be utilized for each antenna group. Access terminal (AT) 1016 is in communication with antennas 1012 and 1014, where antennas 1012 and 1014 transmit information to access terminal 1016 over forward link 1020 and receive information from access terminal 1016 over reverse link 1018. Access terminal 1022 is in communication with antennas 1006 and 1008, where antennas 1006 and 1008 transmit information to access terminal 1022 over forward link 1026 and receive information from access terminal 1022 over reverse link 1024. In a FDD system, communication links 1018, 1020, 1024 and 1026 may use different frequencies for communication. For example, forward link 1020 may use a different frequency then that used by reverse link 1018.

Each group of antennas and/or the area in which they are designed to communicate is often referred to as a sector of the access point. In the aspect, antenna groups each are designed to communicate to access terminals in a sector, of the areas covered by access point 1000.

In communication over forward links 1020 and 1026, the transmitting antennas of access point 1000 utilize beamforming in order to improve the signal-to-noise ratio of forward links for the different access terminals 1016 and 1022. Also, an access point using beamforming to transmit to access terminals scattered randomly through its coverage causes less interference to access terminals in neighboring cells than an access point transmitting through a single antenna to all of its access terminals.

An access point may be a fixed station used for communicating with the terminals and also may be referred to as an access point, a Node B, or some other terminology. An access terminal may also be called user equipment (UE), a wireless communication device, terminal or some other terminology.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

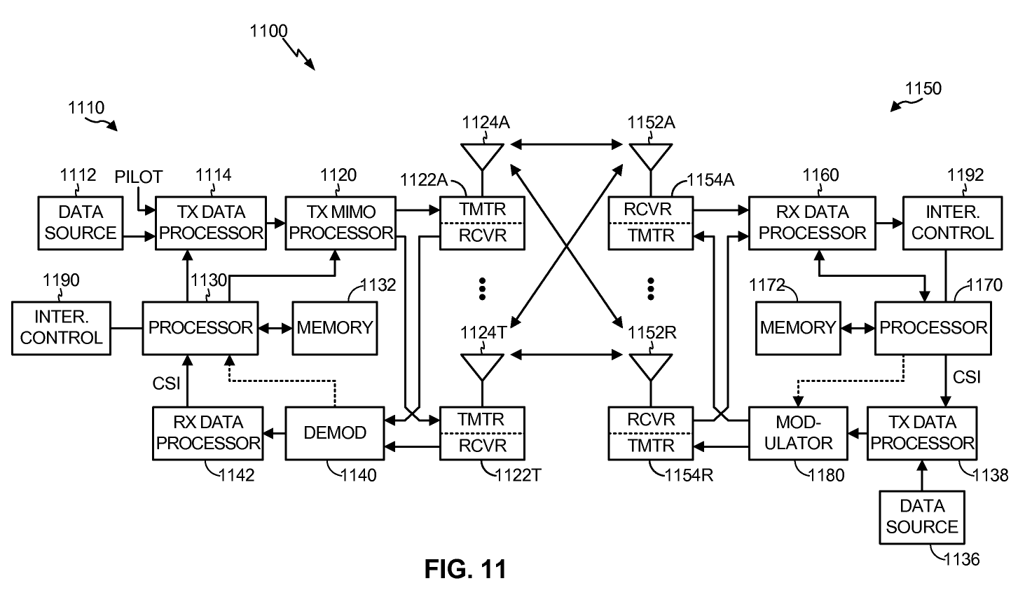

The teachings herein may be incorporated into a node (e.g., a device) employing various components for communicating with at least one other node. FIG. 11 depicts several sample components that may be employed to facilitate communication between nodes. Specifically, FIG. 11 illustrates a wireless device 1110 (e.g., an access point) and a wireless device 1150 (e.g., an access terminal) of a MIMO system 1100. At the device 1110, traffic data for a number of data streams is provided from a data source 1112 to a transmit (“TX”) data processor 1114.

In some aspects, each data stream is transmitted over a respective transmit antenna. The TX data processor 1114 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding and modulation for each data stream may be determined by instructions performed by a processor 1130. A data memory 1132 may store program code, data and other information used by the processor 1130 or other components of the device 1110.

The modulation symbols for all data streams are then provided to a TX MIMO processor 1120, which may further process the modulation symbols (e.g., for OFDM). The TX MIMO processor 1120 then provides N_{T} modulation symbol streams to N_{T} transceivers (“XCVR”) 1122a through 1122t that each has a transmitter (TMTR) and receiver (RCVR). In some aspects, the TX MIMO processor 1120 applies beam-forming weights to the symbols of the data streams and to the antenna from which the symbol is being transmitted.

Each transceiver 1122a-1122t receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1122a through 1122t are then transmitted from N_{T} antennas 1124a through 1124t, respectively.

At the device 1150, the transmitted modulated signals are received by N_{R} antennas 1152a through 1152r and the received signal from each antenna 1152a-1152r is provided to a respective transceiver (“XCVR”) 1154a through 1154r. Each transceiver 1154a-1154r conditions (e.g., filters, amplifies, and downconverts) a respective received signal, digitizes the conditioned signal to provide samples, and further processes the samples to provide a corresponding “received” symbol stream.

A receive (“RX”) data processor 1160 then receives and processes the N_{R} received symbol streams from N_{R} transceivers 1154a-1154r based on a particular receiver processing technique to provide N_{T} “detected” symbol streams. The RX data processor 1160 then demodulates, deinterleaves and decodes each detected symbol stream to recover the traffic data for the data stream. The processing by the RX data processor 1160 is complementary to that performed by the TX MIMO processor 1120 and the TX data processor 1114 at the device 1110.

A processor 1170 periodically determines which pre-coding matrix to use. The processor 1170 formulates a reverse link message comprising a matrix index portion and a rank value portion. A data memory 1172 may store program code, data, and other information used by the processor 1170 or other components of the device 1150.

The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by the transceivers 1154a through 1154r, and transmitted back to the device 1110.

At the device 1110, the modulated signals from the device 1150 are received by the antennas 1124a-1124t, conditioned by the transceivers 1122a-1122t, demodulated by a demodulator (“DEMOD”) 1140 and processed by a RX data processor 1142 to extract the reverse link message transmitted by the device 1150. The processor 1130 then determines which pre-coding matrix to use for determining the beam-forming weights then processes the extracted message.

FIG. 11 also illustrates that the communication components may include one or more components that perform interference control operations. For example, an interference (“INTER.”) control component 1190 may cooperate with the processor 1130 and/or other components of the device 1110 to send/receive signals to/from another device (e.g., device 1150). Similarly, an interference control component 1192 may cooperate with the processor 1170 and/or other components of the device 1150 to send/receive signals to/from another device (e.g., device 1110). It should be appreciated that for each device 1110 and 1150 the functionality of two or more of the described components may be provided by a single component. For example, a single processing component may provide the functionality of the interference control component 1190 and the processor 1130 and a single processing component may provide the functionality of the interference control component 1192 and the processor 1170.

The various operations of methods described above may be performed by various hardware and/or software component(s) and/or module(s) corresponding to means-plus-function blocks illustrated in the figures. Generally, where there are methods illustrated in figures having corresponding counterpart means-plus-function figures, the operation blocks correspond to means-plus-function blocks with similar numbering. For example, operations 400 illustrated in FIG. 4 corresponds to means-plus-function blocks 400A illustrated in FIG. 4A. In addition, operations 500 illustrated in FIG. 5 corresponds to means-plus-function blocks 500A illustrated in FIG. 5A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communications, comprising:
receiving a base sequence and one or more cell-specific sequences from a network;
assigning at least one shift value to a user equipment (UE);
sending information to the UE, wherein the information comprises the base sequence, one of the cell-specific sequences and the shift values; and
receiving a signal from the UE, wherein the signal is generated based at least on the received information.

2. The method of claim 1, further comprising:
determining if the received signal is an acknowledgement (ACK) or a negative acknowledgement (NACK) by an energy detection scheme in a non-coherent transmission mode.

3. The method of claim 2, wherein the determination by the energy detection scheme comprises:
determining a first energy value and a second energy value by multiplying the received signal with a first and a second shifted base sequences;
selecting a smaller of the first and the second energy values as a noise variance;
comparing a ratio of the first and the second energy values with a threshold;
wherein the threshold is a function of the noise variance;
declaring discontinuous transmission if the ratio is less than the threshold and greater than an inverse of the threshold;
declaring ACK if the ratio is larger than the threshold and the first energy value is larger than the second energy value; and
declaring NACK if the ratio is less than the inverse of the threshold and the second energy value is larger than the first energy value.

4. The method of claim 3, wherein the first shifted base sequence is generated by shifting the base sequence with one of the shift values.

5. The method of claim 1, wherein the base sequence is a computer generated sequence (CGS) that is determined based on an identification value.

6. The method of claim 5, wherein the identification value comprises a cell identification or a global identification.

7. The method of claim 1, wherein each of the cell-specific sequences is a column of an orthogonal matrix.

8. The method of claim 7, wherein the orthogonal matrix is a discrete Fourier transform (DFT) matrix.

9. The method of claim 7, wherein different columns of the orthogonal matrix are assigned to different neighboring cells.

10. The method of claim 1, wherein two or more cell-specific sequences are assigned to a cell to increase number of supported UEs.

11. The method of claim 2, wherein the ACK signal is generated based at least on the base sequence and one of the shift values.

12. The method of claim 1, wherein each of the cell-specific sequences comprises a column of a 7×7 discrete Fourier transform (DFT) matrix in a non-coherent transmission mode.

13. The method of claim 1, wherein each of the cell-specific sequences comprises a column of a 4×4 Walsh code or a column of a 3×3 discrete Fourier transform (DFT) matrix in a coherent transmission mode.

14. A method for wireless communications, comprising:
receiving at least two sequences and one or more shift values from a base station;
generating an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode; and
transmitting the ACK or the NACK signals to the base station.

15. The method of claim 14, wherein the sequences comprise a computer generated sequence (CGS) that is determined based on an identification value.

16. The method of claim 14, wherein the sequences comprise a discrete Fourier transform (DFT) sequence or a Walsh code.

17. An apparatus for wireless communications, comprising:
logic for receiving a base sequence and one or more cell-specific sequences from a network;
logic for assigning at least one shift value to a user equipment (UE);
logic for sending information to the UE, wherein the information comprises the base sequence, one of the cell-specific sequences and the shift values; and
logic for receiving a signal from the UE, wherein the signal is generated based at least on the received information.

18. The apparatus of claim 17 further comprising:
logic for determining if the received signal is an acknowledgement (ACK) or a negative acknowledgement (NACK) by an energy detection scheme in a non-coherent transmission mode.

19. The apparatus of claim 18, wherein the logic for determining by the energy detection scheme comprises:
logic for determining a first energy value and a second energy value by multiplying the received signal with a first and a second shifted base sequences;
logic for selecting a smaller of the first and the second energy values as a noise variance;
logic for comparing a ratio of the first and the second energy values with a threshold; wherein the threshold is a function of the noise variance;
logic for declaring discontinuous transmission if the ratio is less than the threshold and greater than an inverse of the threshold;
logic for declaring ACK if the ratio is larger than the threshold and the first energy value is larger than the second energy value; and
logic for declaring NACK if the ratio is less than the inverse of the threshold and the second energy value is larger than the first energy value.

20. The apparatus of claim 19, wherein the first shifted base sequence is generated by shifting the base sequence with one of the shift values.

21. The apparatus of claim 17 wherein the base sequence is a computer generated sequence (CGS) that is determined based on an identification value.

22. The apparatus of claim 21, wherein the identification value comprises a cell identification or a global identification.

23. The apparatus of claim 17 wherein each of the cell-specific sequences is a column of an orthogonal matrix.

24. The apparatus of claim 23, wherein the orthogonal matrix is a discrete Fourier transform (DFT) matrix.

25. The apparatus of claim 23, wherein different columns of the orthogonal matrix are assigned to different neighboring cells.

26. The apparatus of claim 17 wherein two or more cell-specific sequences are assigned to a cell to increase number of supported UEs.

27. The apparatus of claim 18, wherein the ACK signal is generated based at least on the base sequence and one of the shift values.

28. The apparatus of claim 17 wherein each of the cell-specific sequences comprises a column of a 7×7 discrete Fourier transform (DFT) matrix in a non-coherent transmission mode.

29. The apparatus of claim 17 wherein each of the cell-specific sequences comprises a column of a 4×4 Walsh code or a column of a 3×3 discrete Fourier transform (DFT) matrix in a coherent transmission mode.

30. An apparatus for wireless communications, comprising:
logic for receiving at least two sequences and one or more shift values from a base station;
logic for generating an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode; and
logic for transmitting the ACK or the NACK signals to the base station.

31. The apparatus of claim 30, wherein the sequences comprise a computer generated sequence (CGS) that is determined based on an identification value.

32. The apparatus of claim 30, wherein the sequences comprise a discrete Fourier transform (DFT) sequence or a Walsh code.

33. An apparatus for wireless communications, comprising:
means for receiving a base sequence and one or more cell-specific sequences from a network;
means for assigning at least one shift value to a user equipment (UE);
means for sending information to the UE, wherein the information comprises the base sequence, one of the cell-specific sequences and the shift values; and
means for receiving a signal from the UE, wherein the signal is generated based at least on the received information.

34. An apparatus for wireless communications, comprising:
means for receiving at least two sequences and one or more shift values from a base station;
means for generating an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode; and
means for transmitting the ACK or the NACK signals to the base station.

35. A computer-program product for wireless communications, comprising a computer readable medium having instructions stored thereon, the instructions being executable by one or more processors and the instructions comprising:
instructions for receiving a base sequence and one or more cell-specific sequences from a network;
instructions for assigning at least one shift value to a user equipment (UE);
instructions for sending information to the UE, wherein the information comprises the base sequence, one of the cell-specific sequences and the shift values; and
instructions for receiving a signal from the UE, wherein the signal is generated based at least on the received information.

36. A computer-program product for wireless communications, comprising a computer readable medium having instructions stored thereon, the instructions being executable by one or more processors and the instructions comprising:
instructions for receiving at least two sequences and one or more shift values from a base station;
instructions for generating an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode; and
instructions for transmitting the ACK or the NACK signals to the base station.

37. An apparatus for wireless communications, comprising at least one processor configured to:
receive a base sequence and one or more cell-specific sequences from a network;
assign at least one shift value to a user equipment (UE);
send information to the UE, wherein the information comprises the base sequence, one of the cell-specific sequences and the shift values; and
receive a signal from the UE, wherein the signal is generated based at least on the received information.

38. An apparatus for wireless communications, comprising at least one processor configured to:
receive at least two sequences and one or more shift values from a base station;
generate an acknowledgement (ACK) or a negative acknowledgement (NACK) signal based at least on the received sequences and the shift values, wherein the ACK and NACK signals utilize different modulation symbols in a coherent transmission mode or different shift values in a non-coherent transmission mode; and
transmit the ACK or the NACK signals to the base station.
